(19) United States
(12) Patent Application Publication
(10) Pub. No.: US 2007/0283799 A1
(43) Pub. Date: Dec. 13, 2007

(54) APPARATUSES, METHODS AND COMPUTER PROGRAM PRODUCTS INVOLVING PLAYING MUSIC BY MEANS OF PORTABLE COMMUNICATION APPARATUSES AS INSTRUMENTS

(75) Inventors: Carl Andrew Carruthers, Auckland (NZ); Stefan Bengt Gustavsson, Helsingborg (SE); Magnus Fredrik Hansson, Waterloo (CA)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/538,256

(22) Filed: Oct. 3, 2006

Related U.S. Application Data
(60) Provisional application No. 60/804,142, filed on Jun. 7, 2006.

(51) Int. Cl. G10H 7/00

(52) U.S. Cl. 84/645; 84/601

(57) ABSTRACT

Apparatuses, methods and computer program products involving playing music by means of portable communication apparatuses, e.g. mobile telephones, as instruments. According to an embodiment of the invention, a method for generating music data in a portable communication apparatus is provided. A first stream of music data from a first music data generator and a second stream of music data from a second music data generator are received by means of a mixer device of the portable communication apparatus. Furthermore, the first and the second streams of music data are mixed to a third stream of music data. The third stream of music data is fed to a music data player of the portable communication apparatus for playing the third stream of music data.

### RELATED APPLICATIONS

The application claims priority from U.S. Provisional Application Ser. No. 60/804,142, filed Jun. 7, 2006, entitled “Apparatuses, Methods and Computer Program Products Involving Playing Music by Means of Portable Communication Apparatuses as Instruments”, the contents of which are hereby incorporated by reference.

### FIELD OF THE INVENTION

The present invention relates in general to the field of portable communication apparatuses, such as mobile telephones, and more particularly to playing music by means of portable communication apparatuses as instruments.

### DESCRIPTION OF RELATED ART

Music data, such as music data generated according to the MIDI (Musical Instrument Digital Interface) standard specified by the MIDI Manufacturers Association, may be generated by an electronic musical instrument. Such an electronic musical instrument may be included in a portable communication apparatus such as a mobile telephone, e.g. as an entertainment application. For example, some mobile telephones have a music application, which may be used to compose music data using one or several electronic musical instruments. The music data composed may be rendered in the portable communication apparatus in which it is composed, but not in any other apparatus.

Playing music by means of mobile telephones has been briefly discussed in the prior art. For example, US 2004/0176025 A1 describes an arrangement and a method for jointly playing music on mobile telephones by a plurality of users in a so-called MIDI Jamming session. The mobile telephones involved in the MIDI Jamming session rely on synchronizing signals to ensure that they each play their music data sequences at the same time. Each mobile telephone is locked together in time so that the entire ensemble of mobile telephones functions as a single system. One mobile telephone acts as a Master, to which the other mobile telephones acting as Slaves automatically and continuously match their timing. In addition to tempo, different mobile telephones may e.g. be synchronized harmony-wise. The arrangement described in this document is rather complex.

Furthermore, music applications available in portable communication apparatuses cannot in general be shared between multiple users. Therefore, if several persons would like to jointly compose or play a piece of music, they have to compose or play the electronic electrical instrument separately by using multiple apparatuses. Then, the music data that was generated in each apparatus will also be rendered in each apparatus separately. If one person playing one electronic musical instrument would like to listen to the music generated or composed by the other persons in real-time, all persons have to be in relative proximity. The persons have to be sufficiently close to hearing the music rendered in the other persons apparatuses. The noisier the environment in which the music is rendered, the closer the persons have to be situated to adequately hear the music. This can be rather inconvenient for the persons playing.

Hence, an improved system for playing music by means of portable communication apparatuses as instruments would be advantageous.

### SUMMARY OF THE INVENTION

According to an embodiment of the invention, a method for generating music data in a portable communication apparatus is provided. The method comprises receiving in a mixer device of the portable communication apparatus at least a first stream of music data from a first music data generator and a second stream of music data from a second music data generator, mixing the first and the second streams of music data to obtain a third stream of music data, and feeding the third stream of music data to a music data player of the portable communication apparatus for playing the third stream of music data.

The first stream of music data may be received from the first music data generator of the portable communication apparatus. The second stream of music data may be received from the second music data generator of an apparatus external to the portable communication apparatus.

The step of receiving may comprise receiving music data in at least one MIDI message that includes instrument data that identifies the type of instrument used to generate the music data.

The receiving of the second stream of music data may comprise receiving the second stream of music data via a radio transceiver.

Prior to receiving the first stream of music data from the first music data generator of the portable communication apparatus, the method may further comprise detecting input data generated in response to a user interacting with the first music data generator, and generating the first stream of music data in response to the input data. The transmitting may further comprise transmitting, e.g. via a radio transceiver, the first stream of music data to a second mixer device external to the portable communication apparatus.

According to another embodiment, a method for generating music data in mixer equipment is provided. The method comprises receiving, in a mixer device, at least a first stream of music data from a first music data generator of a first portable communication apparatus external to the mixer device, and a second stream of music data from a second music data generator of a second portable communication apparatus external to the mixer device. Furthermore, the method comprises mixing the first and the second stream of music data to obtain a third stream of music data, and transmitting the third stream of music data to at least one of the first and second portable communication apparatuses.

The method may also comprise feeding the third stream of music data to a music data player of the mixer equipment for playing the third stream of music data.

The step of receiving may comprise receiving music data in at least one MIDI message that includes instrument data that identifies the type of instrument used to generate the music data.

The step of transmitting may comprise transmitting the third stream of music data in the MIDI file format, and incorporating in the third stream of music data the type of instrument used to generate the third stream of music data.

The streams of music data may be received via a radio transceiver. Furthermore, the third stream of music data may be transmitted to the at least one of the first and second apparatus via a radio transceiver.

According to yet another embodiment, a method for providing music data to a mixer device from a music data generator of a portable communication apparatus, wherein the mixer device is external to the portable communication apparatus, is provided. The method comprises detecting input data generated in response to a user interacting with the music data generator, generating a first stream of music data in response to the input data transmitting the first stream of music data to the mixer device, receiving, from the mixer device, a second stream of music data, wherein the second stream of music data is based on the first stream of music data and one or more other streams of music data generated by one or several other music data generators, and feeding the second stream of music data to a music data player of the portable communication apparatus for playing the second stream of music data.

The step of generating may comprise generating the first stream of data in the MIDI file format, and incorporating in the first stream of music data the type of instrument used to generate the music data.

The step of transmitting may comprise transmitting the first stream of data in the MIDI file format, and incorporating in the first stream of music data the type of instrument used to generate the music data.

The step of receiving may comprise receiving music data in at least one MIDI message, which comprises instrument data that identifies the type of instrument used to generate the music data.

Furthermore, the step of transmitting of the first stream of music data may comprise transmitting the first stream of music data via a radio transceiver. Moreover, the step of receiving the second stream of music data may comprise receiving the second stream of music data via a radio transceiver.

According to a further embodiment, a computer program product for providing control data in a portable communication apparatus is provided. The computer program product comprises a computer readable medium having computer readable code embodied therein. The computer readable code comprises computer readable code configured to provide control data for a connection for receiving in a mixer device of the portable communication apparatus at least a first stream of music data from a first music data generator and a second stream of music data from a second music data generator, computer readable code configured to provide control data for mixing the first and the second stream of music data to a third stream of music data, and computer readable code configured to provide control data for feeding the third stream of music data to a music data player of the portable communication apparatus for playing the third stream of music data.

According to another embodiment, a computer program product for providing control data in a mixer device is provided. The computer program product comprises a computer readable medium having computer readable code embodied therein. The computer readable code comprises computer readable code configured to provide control data for a connection for receiving in the mixer device at least a first stream of music data from a first music data generator of a first apparatus external to the mixer device, and a second stream of music data from a second music data generator of a second apparatus external to the mixer device, computer readable code configured to provide control data for mixing the first and the second stream of music data to a third stream of music data, and computer readable code configured to provide control data for a connection for transmitting the third stream of music data to at least one of the first and second apparatus.

According to another embodiment, a computer program product for providing control data in a portable communication apparatus is provided. The computer program product comprises a computer readable medium having computer readable code embodied therein. The computer readable code comprises computer readable code configured to provide control data for detecting input data generated in response to a user interacting with a music data generator of the portable communication apparatus, computer readable code configured to provide control data for generating a first stream of music data in response to the input data, computer readable code configured to provide control data for a connection for transmitting the first stream of music data to the mixer device, computer readable code configured to provide control data for a connection for receiving from the mixer device a second stream of music data, the second stream of music data being based on the first stream of music data and possibly one or more other streams of music data generated by one or several other music data generators, and computer readable code configured to provide control data for feeding the second stream of music data to a music data player of the portable communication apparatus for playing the second stream of music data.

According to still another embodiment, a portable communication apparatus for generating music data is provided. The portable communication apparatus comprises a mixer device configured to receive at least a first stream of music data from a first music data generator and a second stream of music data from a second music data generator, mix the first and the second stream of music data to a third stream of music data, and feed the third stream of music data to a music data player of the portable communication apparatus for playing the third stream of music data.

The portable communication apparatus may comprise the first music data generator.

The mixer device may be configured to receive the second stream of music data from the second music data generator, which may be comprised in an apparatus external to the portable communication apparatus. Furthermore, the mixer device may be configured to receive music data in at least one MIDI message, which comprises instrument data that identifies the type of instrument used to generate the music data.

The portable communication apparatus may comprise a radio transceiver operatively connected to the mixer device, wherein the mixer device is configured to receive the second stream of music data via the radio transceiver.

The first music data generator may be configured to detect input data generated in response to a user interacting with the first music data generator, generate the first stream of music data in response to the input data and transmit the first stream of music data to the mixer device.

The portable communication apparatus may comprise a radio transceiver operatively connected to first music data generator, wherein the first music data generator is configured to transmit the first stream of music data to a second mixer device external to the portable communication apparatus via the radio transceiver.

The portable communication apparatus may be a portable or handheld mobile radio communication equipment, a mobile radio terminal, a mobile telephone, a cellular phone, a pager, a communicator, an electronic organizer, or smartphone.

According to a further embodiment, a mixer equipment for generating music data is provided. The mixer equipment comprises a mixer device configured to receive at least a first stream of music data from a first music data generator of a first apparatus external to the mixer equipment and a second stream of music data from a second music data generator of a second apparatus external to the mixer equipment, mix the first and the second stream of music data to a third stream of music data, and transmit the third stream of music data to at least one of the first and second apparatuses.

The mixer equipment may comprise a music data player operatively connected to the mixer device, wherein the mixer device is configured to feed the third stream of music data to the music data player for playing the third stream of music data.

The mixer device may be configured to receive music data in at least one MIDI message, which comprises instrument data that identifies the type of instrument used to generate the music data.

The mixer device may be configured to transmit the third stream of music data in the MIDI file format, and incorporate in the third stream of music data the type of instrument used to generate the third stream of music data.

The mixer equipment may comprise a radio transceiver operatively connected to the mixer device for receiving streams of music data. Furthermore, the mixer equipment may comprise a radio transceiver operatively connected to the mixer device for transmitting the third stream of music data.

The mixer equipment may, for example, be a server, a music application server or a loudspeaker equipment.

According to yet another embodiment a portable communication apparatus for providing music data to a mixer device external to the portable communication apparatus is provided. The portable communication apparatus comprises a music data generator configured to detect input data generated in response to a user interacting with the music data generator, and generate a first stream of music data in response to the input data, wherein the first stream of music data is intended for the mixer device. Furthermore, the portable communication apparatus comprises a radio transceiver operatively connected to the music data generator and configured to transmit the first stream of music data to the mixer device and receive from the mixer device a second stream of music data, wherein the second stream of music data is based on the first stream of music data and possibly one or more other streams of music data generated by one or several other music data generators. The portable communication apparatus also comprises a music data player operatively connected to the radio transceiver, wherein the music data player is configured to receive the second stream of music data for playing the second stream of music data.

The music data generator may be configured to generate the first stream of data in the MIDI file format, and incorporate in the first stream of music data the type of instrument used to generate the music data having the MIDI file format.

The radio transceiver may be configured to transmit the first stream of music data in the MIDI file format, and incorporate in the first stream of music data the type of instrument used to generate the first stream of music data having the MIDI file format.

The radio transceiver may be configured to receive the second stream of music data in at least one MIDI message, which comprises instrument data that identifies the type of instrument used to generate the second stream of music data.

The portable communication apparatus may be a portable or handheld mobile radio communication equipment, a mobile radio terminal, a mobile telephone, a cellular phone, a pager, a communicator, an electronic organizer, a smartphone or a computer.

Further embodiments of the invention are defined in the dependent claims.

Some embodiments of the invention allow for playing a stream of music data at a portable communication apparatus, wherein the played stream of music data is based on one or several streams of music data generated by one or more music data generators. The one or more music data generators may be external to the portable communication apparatus. Accordingly, a user of the portable communication apparatus according to some embodiments of the invention may benefit from playing and listening to music generated or composed by other persons located at remote locations.

Some embodiments of the invention allow for the generation of streams of music data at remote locations and the generation of a common stream of music data based on the remotely generated streams of music data. Thus, the location of the portable communication apparatuses, in which the streams of music data are generated, may be independent.

Some embodiments of the invention may allow for a system of several portable communication apparatuses, wherein all portable communication apparatuses of the system are configured to transmit to all other portable communication apparatuses of the system a stream of music data generated or composed in the portable communication apparatus, and wherein all portable communication apparatuses of the system are configured to receive streams of music data from all other portable communication apparatuses of the system. This may allow for a system of portable communication apparatuses where a group of members may jointly compose and play music. According to some embodiments, each group member may compose music data at its respective portable communication apparatus. Furthermore, each group member may play music data at its respective portable communication apparatus. The played music data may be generated by the portable communication apparatuses of the other group members. According to some embodiments of the invention, this may be accomplished in real-time. This may allow for a situation, which resembles closely to when a real music band meet for composing and playing music together. According to some embodiments of the invention, this may be accomplished even when the portable communication apparatuses are remotely located from each other, e.g. at different locations such as at different continents.

### BRIEF DESCRIPTION OF THE DRAWINGS

Further objects, features and advantages of the invention will appear from the following detailed description of embodiments of the invention, reference being made to the accompanying drawings, in which:

FIG. 1 is a block diagram of an exemplary portable communication apparatus embodied as a mobile telephone.

FIG. 2 is a block diagram of certain components of an embodiment of the portable communication apparatus in FIG. 1.

FIG. 3 is a block diagram of exemplary mixer equipment.

FIG. 4 is a block diagram of certain components of an embodiment of the mixer equipment shown in FIG. 3.

FIG. 5 is a block diagram of certain components of an embodiment of one of the apparatuses in FIG. 3.

FIG. 6 is a flowchart illustrating an embodiment of a method for generating music data in a portable communication apparatus.

FIG. 7 is a flowchart illustrating another embodiment of a method for generating music data in a portable communication apparatus.

FIG. 8 is a flowchart illustrating an embodiment of a method for generating music data in a mixer equipment.

FIG. 9 is a flowchart illustrating an embodiment of a method for providing music data to a mixer device.

### DETAILED DESCRIPTION OF EMBODIMENTS OF THE INVENTION

Embodiments of the invention will be described with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention.

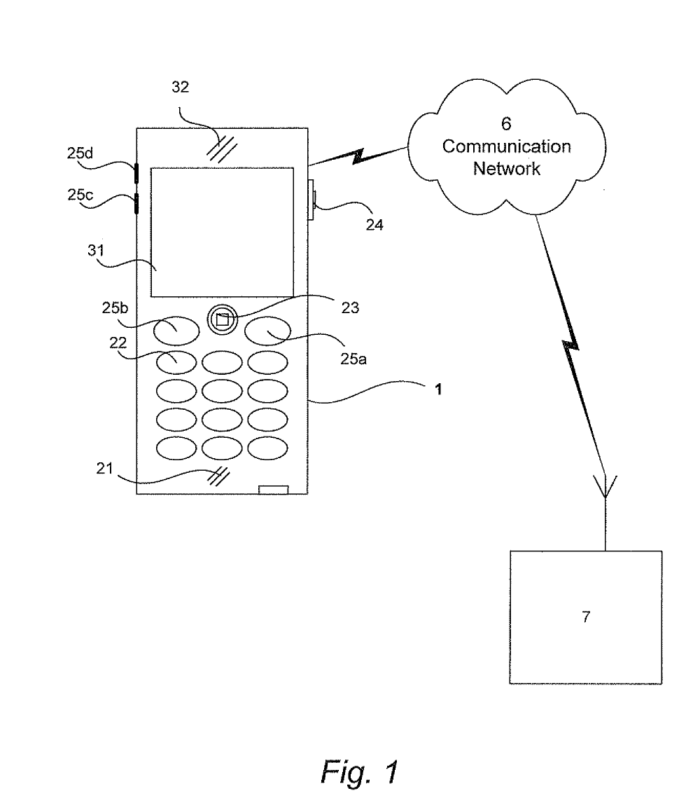

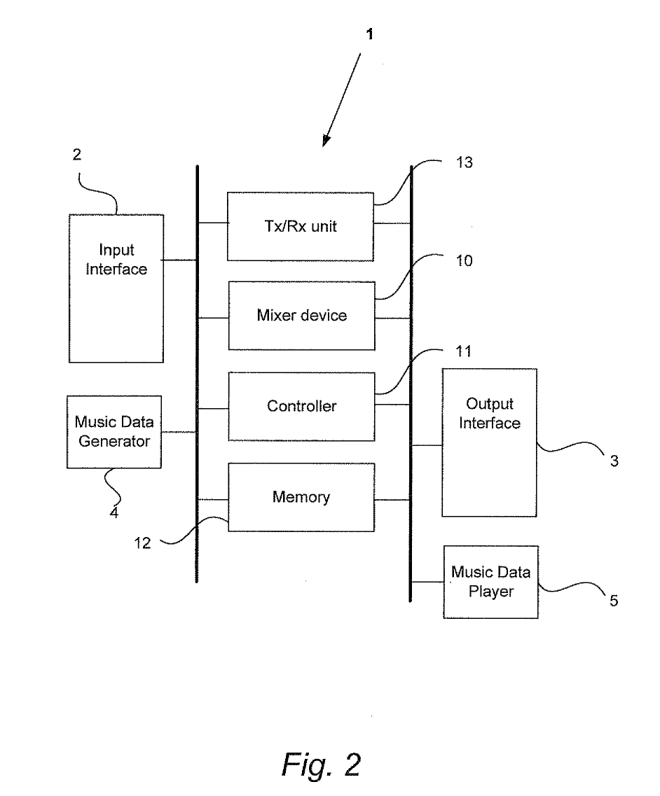

FIG. 1 illustrates a first portable communication apparatus 1. Embodiments of the present invention may be implemented in a wide variety of portable communication apparatuses, which have an input interface 2 (FIG. 2) and an output interface 3 (FIG. 2) through which a user may interact with the first portable communication apparatus 1. The term “portable communication apparatus” as it is used herein may include portable or handheld mobile radio communication equipment, mobile radio terminals, mobile telephones, cellular telephones, pagers, communicators, electronic organizers, smartphones or computers. For simplicity of presentation, the following disclosure will refer to a portable communication apparatus.

The input interface 2 of the first portable communication apparatus 1 may include one or several input means including, but not limited to, a microphone 21, a keypad 22, a joystick 23 or a rocker pad, a scroll button 24, and one or several discrete keys or buttons 25a, 25b, 25c, 25d, e.g. dedicated for certain applications or for making selections among a plurality of selectable items within views of a display 31.

According to some embodiments of the invention, the first portable communication apparatus 1 includes a first music data generator 4 (FIG. 2). The first music data generator 4 may be configured to generate a first stream of music data. The first music data generator 4 may be used to compose a first stream of music data by interacting with one or more of the above-mentioned input means. Thus, a user of the first portable communication apparatus 1 may interact with one or more of the input means for composing a first stream of music data. The first music data generator 4 may be in the form of a music application. The term “music application” as it is used herein may mean software that permits varying the music data. Varying the music data may include, for example, providing or composing musical effects, rhythm patterns, the sound of different instruments (e.g. trumpet, guitar, drums, piano, bass, flute, etc.).

The output interface 3 of the first portable communication apparatus 1 may include one or several output means including, but not limited to, the display 31 and a loudspeaker 32. According to some embodiments of the invention, music data may be played by means of a music data player 5 (FIG. 2) of the first portable communication apparatus 1, e.g. through the loudspeaker 32 or through a headset. Thus, a user of the portable communication device 1 may listen to music through the loudspeaker 32 or through the headset.

The first portable communication apparatus 1 may be configured to communicate over a communication network 6, with other electronic apparatuses and/or with other systems or devices coupled to the communication network 6, such as, for example a second music data generator 7. The second music data generator 7 is configured to generate a second stream of music data. As illustrated in FIG. 1, the second music data generator 7 may be located externally to the first portable communication apparatus 1. Moreover, the second music data generator 7 may be located within an apparatus having communication capabilities, e.g. another portable communication apparatus.

As used herein, the term “communication network” may refer to various radio access technologies in the traditional sense, a wireless local area network (LAN) or a wireless personal area network without departing from the teachings described herein. These networks may include, for example, radio access technologies, such as CDMA (Code Division Multiple Access), EDGE (Enhanced Data rates for GSM Evolution), GPRS (General Packet Radio Service), GSM (Global System for Mobile Telecommunications), HSDPA (High-Speed Downlink Packet Access), HSUPA (High-Speed Uplink Packet Access), UMTS (Universal Mobile Telecommunications System), WCDMA (Wideband Code Division Multiple Access, and/or WCDMA+EDGE (WEDGE) and/or Wireless Local Area Networks (WLAN), such as Wireless Fidelity (WiFi) and Worldwide Interoperability for Microwave Access (WiMAX). Furthermore, these networks may include, for example, short-range radio access technologies, e.g. Bluetooth. Yet further, these networks may include an IP-based (Internet Protocol) infrastructure, such as IMS (IP Multimedia Subsystem).

According to some embodiments, a mixer device of the first portable communication apparatus 1 is configured to receive at least a first stream of music data from the first music data generator 4 (FIG. 2) and a second stream of music data from the second music data generator 7. The second stream of music data may e.g. be received from the second music data generator 7 via the communication network 6. Consequently, the first portable communication apparatus 1 according to some embodiments of the invention is capable of receiving a plurality of steams of music data generated by one or several music data generators.

Furthermore, the mixer device of the first portable communication apparatus 1 is configured to mix the first and the second stream of music data to a third stream of music data. The third stream of music data may be the sum of the first and the second stream of music data. Moreover, the mixer device of the first portable communication apparatus 1 is configured to feed the third stream of music data to a music data player 5 of the first portable communication apparatus 1 for playing the third stream of music data. Accordingly, the first portable communication apparatus 1 according to some embodiments is capable of playing music data, which has been generated by one or several music data generators. Each of the one or several music data generators may be located externally to the first portable communication apparatus 1.

As it is used herein the term “music data” may refer to any kind of music data. The music data may be a sound sample of a first format. The sound sample of the first format may be played directly. Alternatively, the sound sample of the first format may first be converted to a second format prior to being played. Additionally, or alternatively, the music data may be in a MIDI file format. For example, the music data may be in the form of a MIDI control message. The music data, e.g. in the MIDI file format, may comprise instrument data that identifies the type of instrument(s) used to generate the music data. The type of instrument may include, for example, trumpet, guitar, drums, piano, bass, flute, etc. In the following, embodiments of the invention will be described in the context of MIDI for convenience because it is a well-known, commercially available standard. However, other standards could be used instead, and the invention should not be confined to MIDI.

FIG. 2 illustrates certain components or units of an embodiment of the first portable communication apparatus 1, which may be involved in generating the music data in the first portable communication apparatus 1. In the embodiment illustrated in FIG. 2, the portable communication device 1 comprises a mixer device 10, a controller 11, a memory 12, a transceiver (Tx/Rx) 13, the input interface 2, the output interface 3, the first music data generator 4, and the music data player 5 operatively connected to each other.

The mixer device 10 is configured to receive at least a first stream of music data from the first music data generator 4 and a second stream of music data from the second music data generator 7 (FIG. 1). The third stream of music data may be the sum of the first and the second stream of music data. Furthermore, the mixer device 10 is configured to mix the first and the second stream of music data to a third stream of music data. Moreover, the mixer device 10 is configured to feed the third stream of music data to a music data player 5 of the first portable communication apparatus for playing the third stream of music data. The mixer device may, for example, be configured to receive music data in at least one MIDI message. The controller 11 may be a processor, such as a central processing unit (CPU). The mixer device 10 may be software implemented, e.g. a separate application run by the controller 11. However, the mixer device 10 may alternatively be provided as a separate hardware unit, such as a CPU, an integrated circuit, such as an ASIC (Application Specific Integrated Circuit) or a FPGA (Field Programmable Gate Array).

In the embodiment illustrated in FIG. 2, the portable communication apparatus 1 comprises the first music data generator 4. The first music data generator 4 is configured to detect input data generated in response to a user interacting with the first music data generator via one or more input means of the user interface 2. The first music data generator 4 is adapted to generate the first stream of music data in response to the detected input data. Furthermore, the first music data generator 4 is adapted to transmit the first stream of music data to the mixer device 10. Accordingly, the first music data generator 4 is used to compose or play streams of music data. The choice of musical instrument (e.g. trumpet, guitar, drums, piano, bass, flute, etc.) replicated by the first portable communication apparatus 1 may be selected, for example, by the user via the input interface 1. The first music data generator 4 may be software implemented, such as a separate application run by the controller 11. However, the first music data generator 4 may alternatively be provided as a separate hardware unit, such as a CPU, or an integrated circuit, such as an ASIC or a FPGA.

In the embodiment illustrated in FIG. 2, the portable communication apparatus comprises the music data player 5 for playing streams of music data, e.g. via the loudspeaker 32 of the output interface 3. The music data player 5 may be software implemented, such as a separate application run by the controller 11. However, the music data player 5 may alternatively be provided as a separate hardware unit, such as a CPU or an integrated circuit, such as an ASIC or a FPGA.

Furthermore, the first portable communication apparatus 1 may comprise various memories, such as a RAM (Random Access Memory), and a ROM (Read Only Memory) shown collectively as memory 12. In the memory, at least music data may be stored.

In the embodiment illustrated in FIG. 2, the first portable communication apparatus 1 comprises a transceiver (Tx/Rx) 13. The transceiver 13 may comprise a radio transceiver or a short-range radio transceiver. Alternatively, the transceiver 13 may comprise a combination of both a radio transceiver and a short-range radio transceiver. The transceiver 13 may be configured to communicate over the communication network 6, with other electronic apparatuses and/or with other systems or devices coupled to the communication network 6, for example the second music data generator 7 located within a device with communication capabilities. Accordingly, the mixer device 10 may be configured to receive the second stream of music data from the second music data generator 7 via the transceiver 13 when the first portable communication apparatus 1 is in communication with the second music data generator 7. Moreover, the first music data generator 4 may be configured to transmit the first stream of music data to a second mixer device external to the first portable communication apparatus 1 via the transceiver 13 when the first portable communication apparatus 1 is in communication with said second mixer device 6.

With reference to FIGS. 1 and 2, possible user scenarios will now be described. A user of the first portable communication apparatus 1 may interact with the one or more input means of the input interface 2 for composing a first stream of music data by means of the first music data generator 4. The first music data generator 4 may detect input data generated in response to the user interacting with the first music data generator 4 via one or more of the input means. Furthermore, the first music generator 4 may generate a first stream of music data in response to the input data, and transmit the first stream of music data to the mixer device 10. Furthermore, the mixer device 10 may receive a second stream of music data from the second music data generator 7. The second stream of music data may e.g. be received by the mixer device 10 via the transceiver 13 when the first portable communication apparatus 1 is in communication with the second music data generator 7 over the communication network 6. Then, the first and the second stream of music data may be mixed by the mixer device 10 to a third stream of music data. Subsequently, the third stream of music data may be fed to the music data player 5 of the portable communication apparatus 1. The third stream of music data, which is based on the first and the second streams of music data, may be played by the music data player 5, for example, via the loudspeaker 32. Accordingly, a user of the first portable communication apparatus 1 may play and thus listen to music at the first portable communication apparatus 1.

Some embodiments may allow for joint playing of music on portable communication apparatuses by a group of users. Imagine a situation where the users of the group of users are not located in the same geographic location, but are instead located far away from each other. That is, the portable communication apparatuses of the users are located remotely from each other. In some embodiments each of the users may interact with a music data generator, on their own respective portable communication apparatus for generating or composing music data. The generated music data may be transmitted to the other participating portable communication apparatuses. Each of the portable communication apparatuses of the participating users may receive music data generated by the portable communication apparatuses of the other participating users. Some embodiments thus allow for the generation of a common stream of music data at each portable communication apparatus, wherein the common stream of music data is based on the streams of music data generated by the other participating portable communication apparatuses. The location of the portable communication apparatuses, in which the streams of music data are generated, may be independent. Users of portable communication apparatuses according to some embodiments may be remotely located from each other at different geographic locations and still benefit from jointly composing and/or listening to music together. The user experience may thus resemble closely to the situation when musicians of a real music band meet at a common place for composing and playing music together. Furthermore, according to some embodiments, the joint playing of music may be accomplished in real-time. When the portable communication apparatuses of a group of users are located remotely from each other, it may be advantageous to use, for example, a UMTS network or a GSM network as the communication network 6 for communicating the streams of music data between the participating portable communication apparatuses.

Let us next imagine a situation where a group of users are located in the same geographic location (and the portable communication apparatuses of the users are within earshot of one another) where the playing environment is acoustically unsuitable. Since the playing environment is acoustically unsuitable, it may be advantageous to play the music data generated by all the participating portable communication apparatuses at all the participating portable communication apparatuses. This situation is similar to the previous situation. However, when the portable communication apparatuses of a group of users are located in relative proximity to each other, it may be advantageous to use a short communication protocol such as Bluetooth for communicating the streams of music data between the participating portable communication apparatuses. Compared with a GSM or UMTS network, Bluetooth may allow for better interaction and less compensation for delays of the streams of music data that are communicated between participating portable communication apparatuses.

Let us next imagine a situation where a group of users are located in the same geographic location (and the portable communication apparatuses of the users are within earshot of one another), wherein the playing environment is acoustically suitable. This situation is similar to the previous situation. However, in this situation it is not necessary that each of the portable communication apparatuses play the music data generated by all portable communication apparatuses. Rather, one of the portable communication apparatuses may be assigned to play the music data generated by the other participating portable communication apparatus. This assignment may e.g. be based on verbal negotiations between participants. Furthermore, the choice of musical instruments replicated by each portable communication apparatus of the group may also be based on verbal negotiations between participants. It may be an advantage that the playing of the streams of music data generated by the participating portable communication apparatuses are played in only one assigned portable communication apparatus. An advantage is that the total processing power required by all participating portable communication apparatus may be kept to a minimum.

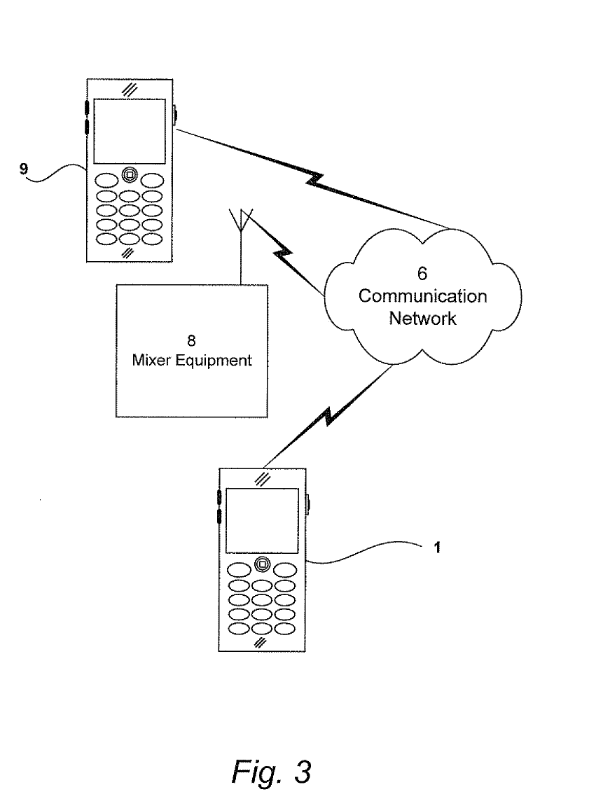

With reference to FIG. 3, mixer equipment 8 is shown. Embodiments described herein may be implemented in a wide variety of mixer equipments. According to some embodiments of the invention, the mixer equipment 8 need not have any man-machine interface. The mixer equipment may, e.g., be a server, a music application server or a loudspeaker-based equipment. For simplicity of presentation, reference will however be made to a mixer equipment 8 in the following. Besides what is described below with reference to FIG. 3, the elements of FIG. 3 having corresponding reference signs in FIG. 1 operate and interact similarly to the description of FIG. 1.

The mixer equipment 8 may be configured to communicate over the communication network 6, with other electronic apparatuses and/or with other systems or devices coupled to the communication network 6, for example a first apparatus 1 and a second apparatus 9. The first and the second apparatuses 1, 9 are external to the mixer equipment 8. The first apparatus may be the first portable communication apparatus 1 previously described. The second apparatus may be a second portable communication apparatus 9, which will be further described below.

According to embodiments described herein, a mixer device of the mixer equipment 8 is configured to receive at least a first stream of music data from a first music data generator of the first apparatus 1 and a second stream of music data from a second music data generator of the second apparatus 9. Furthermore, the mixer device of mixer equipment 8 is configured to mix the first and the second stream of music data to a third stream of music data. The third stream of music data may be the sum of the first and the second stream of music data. Moreover, the mixer device of the mixer equipment 8 is configured to transmit the third stream of music data to at least one of the first and second apparatuses 1, 9. Accordingly, some embodiments allow for the generation of streams of music data at remote locations and the generation of a common stream of music data based on the remotely generated streams of music data at the mixer equipment 8. Consequently, the location of the apparatuses, in which the streams of music data are generated, may be independent. Moreover, the common stream of music data generated in the mixer device of the mixer equipment 8 may be transmitted to one or more of the remote apparatuses 1, 9 that transmitted their respective streams of music data to the mixer equipment 8. In some embodiments of the invention, the common stream of music data may be transmitted to all remote apparatuses 1, 9 that transmitted their respective streams of music data to the mixer equipment 8.

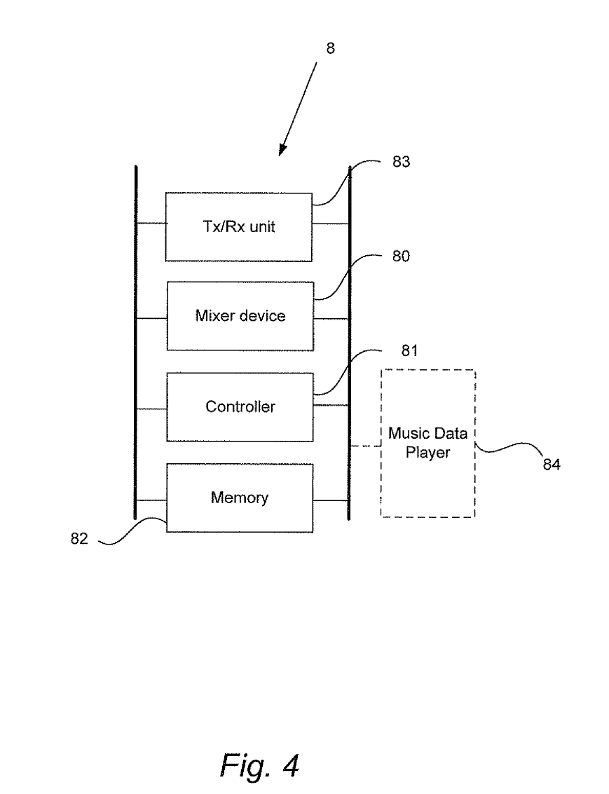

FIG. 4 illustrates certain components or units of an embodiment of the mixer equipment 8, which may be involved in generating music data. In the embodiment illustrated in FIG. 4, the mixer equipment 8 comprises a mixer device 80, a controller 81, a memory 82, and a transceiver 83 operatively connected to each other. Furthermore, in other embodiments the mixer equipment 8 may also comprise a music data player 84.

The mixer device 80 is configured to receive at least the first stream of music data from the first music data generator of the first apparatus 1 and the second stream of music data from the second music data generator of the second apparatus 9. Furthermore, the mixer device 80 is configured to mix the first and the second stream of music data to a third stream of music data, and transmit the third stream of music data to at least one of the first and second apparatus 1, 9.

The controller 81 may be a processor, such as a CPU. The mixer device 80 may be software implemented, e.g. a separate application run by the controller 81. However, the mixer device 80 may alternatively be a separate hardware unit, such as a CPU or an integrated circuit, such as an ASIC or a FPGA.

Furthermore, the mixer equipment 8 may comprise various memories, such as a RAM and a ROM, shown collectively as memory 82. In the memory, at least music data may be stored.

The mixer equipment also comprises a transceiver 83. The transceiver 83 may comprise a radio transceiver or a short-range radio transceiver. Alternatively, the transceiver 83 may comprise a combination of both a radio transceiver and a short-range radio transceiver. The transceiver 83 may be configured to communicate over the communication network 6, with other electronic apparatuses and/or with other systems or devices coupled to the communication network 6. Thus, the mixer device 80 may be configured to receive streams of music data from external apparatuses, e.g. the first and second apparatuses 1, 9, via the transceiver 13. Moreover, the mixer device may be configured to transmit the generated third stream of music data to one or more of the external apparatuses, e.g. the first and second apparatuses 1, 9, via the transceiver 83.

According to some embodiments of the invention, a music data player 84 for playing of music data may be provided in the mixer equipment 8. The mixer device 80 may be configured to feed the third stream of music data to the music data player 84 for playing the third stream of music data, e.g. through a loudspeaker (not shown) of the mixer equipment 8. Such music data player 84 may be software implemented, e.g. a separate application run by the controller 81. However, the music data player 84 may alternatively be provided as a separate hardware unit, such as a CPU or an integrated circuit, such as an ASIC or a FPGA.

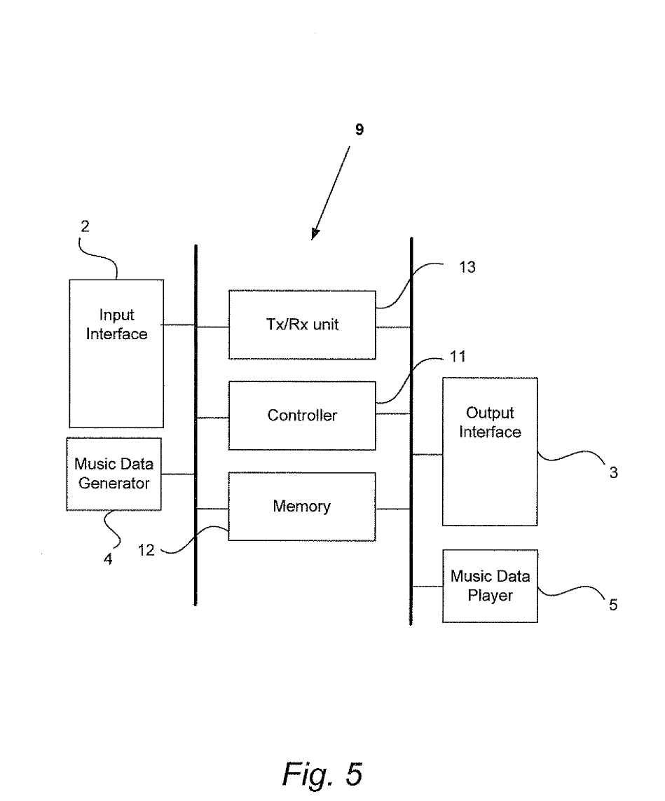

FIG. 5 illustrates certain components or units of an embodiment of the second portable communication apparatus 9, which may be involved in providing music data to a mixer device, which is external to the second portable communication apparatus 9. The mixer device that is external to the second portable communication apparatus 9 may be the mixer device 80 of the mixer equipment 8 (FIG. 4). Alternatively, or additionally, the mixer device that is external to the second portable communication apparatus 9 may be the mixer device 10 of the first portable communication apparatus 1 (FIG. 2). Besides what is described below with reference to FIG. 5, the elements of FIG. 5 having corresponding reference signs in FIG. 2 operate and interact similarly to the description of FIG. 2. The second portable communication apparatus 9 differs from the first portable communication apparatus 1 in that it does not include a mixer device.

The second portable communication apparatus 9 shown in FIG. 5 may include a music data generator 5 configured to detect input data generated in response to a user interacting with the music data generator 5, e.g. via one or several input means of the input interface of the second portable communication apparatus 9. Furthermore, the music data generator 5 is configured to generate a first stream of music data in response to the input data. The first stream of music data is intended for a mixer device 10, 80 that is external to the second portable communication apparatus 9.

A transceiver 13 may be operatively connected to the music data generator 5. The transceiver 13 may comprise a radio transceiver or a short-range radio transceiver. Alternatively, the transceiver 13 may comprise a combination of a radio transceiver and a short-range radio transceiver. The transceiver 13 may be configured to transmit the first stream of music data to the mixer device 10, 80. Furthermore, the transceiver 13 may be configured to receive from the mixer device 10, 80 a second stream of music data. The second stream of music data is based on the first stream of music data and possibly one or more other streams of music data generated by one or several other music data generators.

Moreover, a music data player 5 may be operatively connected to the transceiver 13. The music data player 5 may be configured to receive the second stream of music data from the mixer device via the transceiver 13 for playing the second stream of music data, e.g. via a loudspeaker of the second portable communication apparatus 9.

It may be an advantage that the mixing of the streams of music data is performed by a mixer device that is external to the second portable communication apparatus 9. In this way, the processing power required by the second portable communication apparatus 9 may be limited. This may be advantageous when the second portable communication apparatus 9 is an apparatus with limited battery power and/or data transfer rate, such as e.g. a mobile telephone.

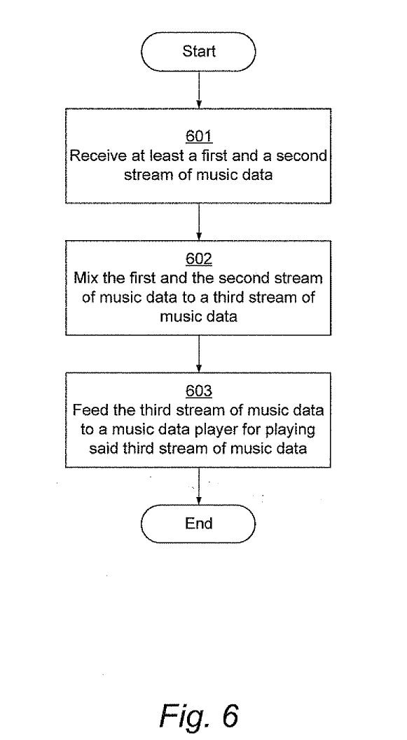

FIG. 6 is a flow chart illustrating exemplary operations for generating music data in a first portable communication apparatus 1. In step 601, at least a first stream of music data from a first music data generator and a second stream of music data from a second music data generator are received by a mixer device of the first portable communication apparatus 1. The first stream of music data is received from the first music data generator, which may be located within the first portable communication apparatus 1. Furthermore, the second stream of music data is received from the second music data generator, which may be located in an apparatus external to the first portable communication apparatus 1. If the second music data generator is located in an apparatus external to the first portable communication apparatus 1, the step of receiving the second stream of music data may comprise receiving the second stream of music data via a radio transceiver of the first portable communication apparatus 1. Furthermore, the step 601 of receiving may comprise receiving music data in at least one MIDI message. The MIDI message may comprise instrument data that identifies the type of instrument used to generate the music data. In step 602, the first and the second stream of music data are mixed to a third stream of music data. The third stream of music data may be the sum of the first and the second streams of music data. The third stream of music data is fed, in step 603, to a music data player of the first portable communication apparatus for playing the third stream of music data.

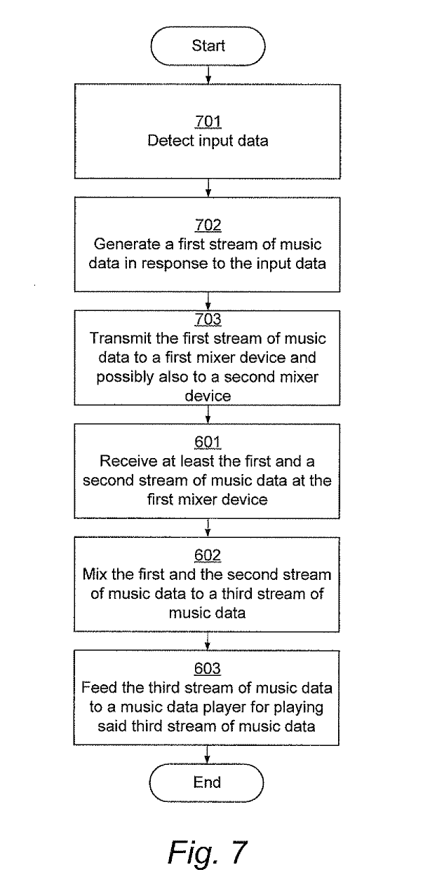

FIG. 7 is a flow chart illustrating operations consistent with another embodiment for generating music data in a first portable communication apparatus 1. Blocks 601, 602, and 603 in FIG. 7 correspond to like functionality as described for FIG. 6, and will therefore not be further explained here. Prior to receiving the first stream of music data in step 601, the method according to the embodiment shown in FIG. 7 includes steps 701-703. In step 701, input data generated in response to a user interacting with the first music data generator is detected. In step 702, the first stream of music data is generated in response to the input data. The first stream of music data is transmitted to the mixer device of the first portable communication apparatus 1 in step 703. The step of transmitting, i.e. step 703, may also comprise transmitting the first stream of music data to a second mixer device, which is external to the first portable communication apparatus 1. This could be accomplished by transmitting the first stream of music data to the external mixer device via the radio transceiver of the first portable communication apparatus 1.

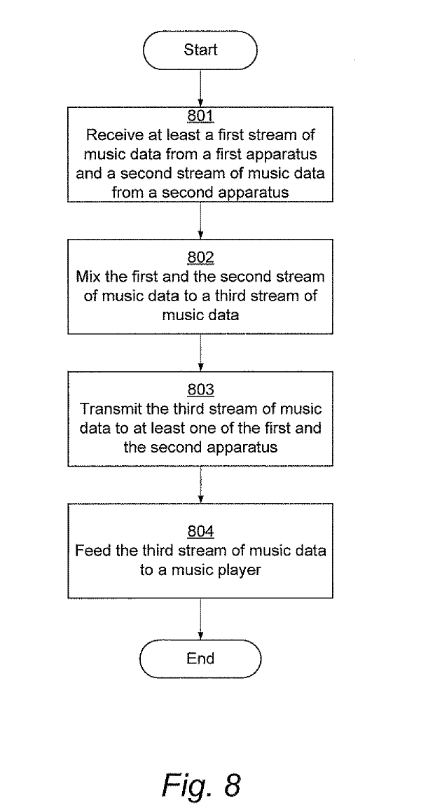

FIG. 8 illustrates an embodiment of a method for generating music data in a mixer equipment 8. In step 801, at least a first stream of music data from a first music data generator of a first apparatus external to the mixer device and a second stream of music data from a second music data generator of a second apparatus external to the mixer device are received by a mixer device of the mixer equipment 8. For example, the streams of music data may be received via a radio transceiver of the mixer equipment 8. In step 802, the first and the second stream of music data are mixed to a third stream of music data. The third stream of music data is transmitted, in step 803, to at least one of the first and second apparatus. The step of transmitting, i.e. step 803, may comprise transmitting the third stream of music data in the MIDI file format, and incorporating in the third stream of music data the type of instrument used to generate the third stream of music data having the MIDI file format. Furthermore, the third stream of music data may be transmitted to at least one of the first and second apparatus via the radio transceiver of the mixer equipment 8.

The method may also comprise feeding, in step 804, the third stream of music data to a music data player of the mixer equipment for playing the third stream of music data at the mixer equipment 8. However, it should be appreciated that step 804 may be omitted in some embodiments of the invention, e.g. because it is not desired to play the music data at the mixer equipment 8 or because the mixer equipment lacks a playing capability.

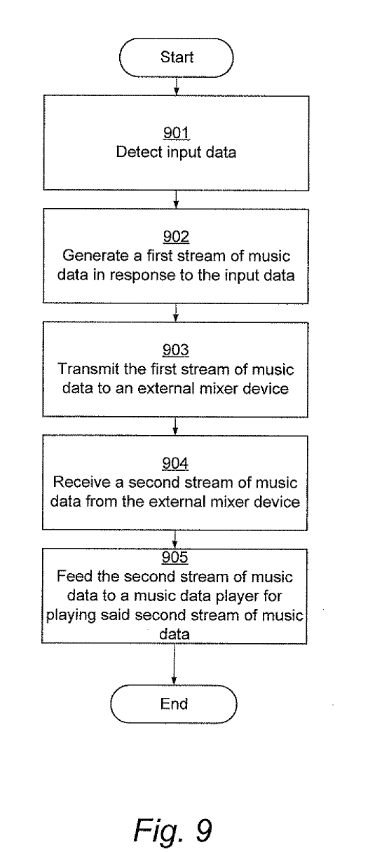

FIG. 9 is a flow chart illustrating operations for providing music data to a mixer device from a music data generator of a second portable communication apparatus 9. The mixer device may be external to the second portable communication apparatus 9. In step 901, input data generated in response to a user interacting with the music data generator is detected. In step 902, a first stream of music data is generated in response to the input data. The first stream of music data is intended for the mixer device that is external to the second portable communication apparatus 9. The step 902 of generating the first stream of data may comprise generating the first stream of data in the MIDI file format, and incorporating in the first stream of music data the type of instrument used to generate the music data having the MIDI file format. In step 903, the first stream of music data is transmitted to the mixer device. The step 903 of transmitting may comprise transmitting the first stream of data in the MIDI file format, and incorporating in the first stream of music data the type of instrument used to generate the music data having the MIDI file format. Furthermore, the step 903 of transmitting the first stream of music data may comprise transmitting the first stream of music data to the mixer device by means of a radio transceiver of the second portable communication apparatus 9. A second stream of music data is received from the mixer device in step 904. The second stream of music data is based on the first stream of music data and possibly one or more other streams of music data generated by one or several other music data generators. The receiving of the second stream of music data in step 904 may comprise receiving music data in at least one MIDI message, which comprises instrument data that identifies the type of instrument used to generate the music data. Moreover, the receiving of the second stream of music data may comprise receiving the second stream of music data from the mixer device by means of the radio transceiver of the second portable communication apparatus 9. In step 905, the second stream of music data is fed to a music data player of the second portable communication apparatus for playing the second stream of music data.

As used herein, the singular forms “a”, “an” and “the” are intended to include the plural forms as well, unless expressly stated otherwise. It will be further understood that the terms “includes,” “comprises,” “including” and/or “comprising,” when used in this specification and claims, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a portable communication apparatus such as a mobile telephone, a mixer equipment, a method or a computer program product. Accordingly, the present invention may take the form of an entirely hardware embodiment, a software embodiment or an embodiment combining software and hardware aspects. Furthermore, the present invention may take the form of a computer program product. The computer program product may be stored on a computer-usable storage medium having computer-usable program code embodied in the medium. Any suitable computer readable medium may be utilized including hard disks, CD-ROMs, a RAM, a ROM, a flash memory, optical storage devices, a transmission media such as those supporting the Internet or an intranet, or magnetic storage devices.

Embodiments of the present invention have been described herein with reference to flowchart and/or block diagrams. It will be understood that some or all of the illustrated blocks may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or otherwise described.

These computer program instructions may also be stored in a computer-readable memory that can direct a computer or other programmable data processing apparatus to function in a particular manner, such that the instructions stored in the computer-readable memory produce an article of manufacture including instructions that implement the functions/acts specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the diagrams may occur out of the order noted in the operational illustrations. For example, two blocks shown in succession may in fact be executed substantially concurrently or the blocks may sometimes be executed in the reverse order, depending upon the functionality/acts involved.

A computer program product may comprise computer program code portions for executing the method, as described in the description and the claims, for providing control data when the computer program code portions are run by an electronic device having computer capabilities.

A computer readable medium having stored thereon a computer program product may comprise computer program code portions for executing the method, as described in the description and the claims, for providing control data when the computer program code portions are run by an electronic device having computer capabilities.

A computer program product may comprise computer program code portions for executing the method, as described in the description and the claims, for requesting control data when the computer program code portions are run by an electronic device having computer capabilities.

A computer readable medium having stored thereon a computer program product may comprise computer program code portions for executing the method, as described in the description and the claims, for requesting control data when the computer program code portions are run by an electronic device having computer capabilities.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. The different features and steps of the invention may be combined in other combinations than those described. The scope of the invention is only limited by the appended patent claims.

What is claimed is:

1. A method for generating music data in a portable communication apparatus, comprising:
receiving in a mixer device of the portable communication apparatus at least a first stream of music data from a first music data generator and a second stream of music data from a second music data generator;
mixing the first and the second streams of music data to obtain a third stream of music data; and
feeding the third stream of music data to a music data player of the portable communication apparatus for playing the third stream of music data.

2. The method of claim 1, wherein the first music data generator is included in the portable communication apparatus.

3. The method of claim 2, wherein the second music data generator is located external to the portable communication apparatus.

4. The method of claim 1, wherein the receiving comprises receiving music data in at least one MIDI message, that includes instrument data that identifies a type of instrument used to generate the music data.

5. The method of claim 3, wherein the receiving of the second stream of music data includes receiving the second stream of music data via a radio transceiver.

6. The method of claim 2, further comprising, prior to receiving the first stream of music data:
detecting input data generated in response to a user interacting with the first music data generator; and
generating the first stream of music data in response to the input data.

7. The method of claim 6, further comprising:
transmitting via a radio transceiver the first stream of music data to a second mixer device external to the portable communication apparatus.

8. A method for generating music data comprising:
receiving, in a mixer device, at least a first stream of music data from a first portable communication music data generator of a first apparatus external to the mixer device;
receiving, in a mixer device, a second stream of music data from a second music data generator of a second portable communication apparatus external to the mixer device;
mixing the first and the second stream of music data to obtain a third stream of music data; and
transmitting the third stream of music data to at least one of the first and second portable communication apparatuses.

9. The method of claim 8, further comprising:
feeding the third stream of music data to a music data player of the mixer equipment for playing the third stream of music data.

10. The method of claim 8, wherein the receiving comprises receiving music data in at least one MIDI message that includes instrument data that identifies a type of instrument used to generate the music data.

11. The method of claim 10, wherein the transmitting comprises transmitting the third stream of music data in the MIDI file format, and incorporating in the third stream of music data the type of instrument used to generate the third stream of music data having the MIDI file format.

12. The method of claim 8, wherein the first and second streams of music data are received via a radio transceiver.

13. The method of claim 8, wherein the third stream of music data is transmitted via a radio transceiver.

14. A method for providing music data to a mixer device from a music data generator of a portable communication apparatus, the mixer device being external to the portable communication apparatus, the method comprising:
detecting input data generated in response to a user interacting with the music data generator;
generating a first stream of music data in response to the input data;
transmitting the first stream of music data to the mixer device;
receiving, from the mixer device, a second stream of music data, the second stream of music data being based on the first stream of music data and one or more other streams of music data generated by one or more other music data generators; and
feeding the second stream of music data to a music data player of the portable communication apparatus for playing the second stream of music data.

15. The method of claim 14, wherein the generating comprises generating the first stream of data in a MIDI file format, and incorporating in the first stream of music data a type of instrument used to generate the music data having the MIDI file format.

16. The method of claim 15, wherein the transmitting comprises transmitting the first stream of data in the MIDI file format, and incorporating in the first stream of music data the type of instrument used to generate the music data having the MIDI file format.

17. The method of claim 16, wherein the receiving comprises receiving music data in at least one MIDI message that includes instrument data that identifies the type of instrument used to generate the music data.

18. The method of claim 14, wherein the transmitting of the first stream of music data comprises transmitting the first stream of music data via a radio transceiver.

19. The method of claim 14, wherein the receiving of the second stream of music data comprises receiving the second stream of music data via a radio transceiver.

20. A computer program product for providing control data in a portable communication apparatus, the computer program product comprising:
a computer readable medium having computer readable code embodied therein, the computer readable code comprising:
computer readable code configured to provide control data for a connection for receiving in a mixer device of the portable communication apparatus at least a first stream of music data from a first music data generator and a second stream of music data from a second music data generator;
computer readable code configured to provide control data for mixing the first and the second streams of music data to obtain a third stream of music data; and
computer readable code configured to provide control data for feeding the third stream of music data to a music data player of the portable communication apparatus for playing the third stream of music data.

21. A computer program product for providing control data in a mixer device, the computer program product comprising:
a computer readable medium having computer readable code embodied therein, the computer readable code comprising:
computer readable code configured to provide control data for a connection for receiving, in the mixer device, at least a first stream of music data from a first music data generator of a first portable communication apparatus external to the mixer device, and a second stream of music data from a second music data generator of a second portable communication apparatus external to the mixer device;
computer readable code configured to provide control data for mixing the first and the second stream of music data to obtain a third stream of music data; and
computer readable code configured to provide control data for a connection for transmitting the third stream of music data to at least one of the first and second portable communication apparatuses.

22. A computer program product for providing control data in a portable communication apparatus, the computer program product comprising:
a computer readable medium having computer readable code embodied therein, the computer readable code comprising:
computer readable code configured to provide control data for detecting input data generated in response to a user interacting with a music data generator of the portable communication apparatus;
computer readable code configured to provide control data for generating a first stream of music data in response to the input data;
computer readable code configured to provide control data for a connection for transmitting the first stream of music data to the mixer device;
computer readable code configured to provide control data for a connection for receiving, from the mixer device, a second stream of music data, the second stream of music data being based on the first stream of music data and one or more other streams of music data generated by one or several other music data generators; and
computer readable code configured to provide control data for feeding the second stream of music data to a music data player of the portable communication apparatus for playing the second stream of music data.

23. A portable communication apparatus for generating music data, comprising:
a mixer device configured to receive at least a first stream of music data from a first music data generator and a second stream of music data from a second music data generator, mix the first and the second streams of music data to obtain a third stream of music data, and feed the third stream of music data to a music data player of the portable communication apparatus for playing the third stream of music data.

24. The portable communication apparatus of claim 23, wherein the first music data generator is included in the portable communication apparatus.

25. The portable communication apparatus of claim 24, wherein the second music data generatoris located in an apparatus external to the portable communication apparatus.

26. The portable communication apparatus of claim 23, wherein the mixer device is configured to receive music data in at least one MIDI message that includes instrument data that identifies a type of instrument used to generate the music data.

27. The portable communication apparatus of claim 25, wherein the portable communication apparatus comprises a radio transceiver operatively connected to the mixer device and the mixer device is configured to receive the second stream of music data via the radio transceiver.

28. The portable communication apparatus of claim 24, wherein the first music data generator is configured to detect input data generated in response to a user interacting with the first music data generator, generate the first stream of music data in response to the input data and transmit the first stream of music data to the mixer device.

29. The portable communication apparatus of claim 28, wherein the portable communication apparatus comprises a radio transceiver operatively connected to the first music data generator and the first music data generator is configured to transmit the first stream of music data to a second mixer device external to the portable communication apparatus via the radio transceiver.

30. The portable communication apparatus of claim 23, wherein the portable communication apparatus is an apparatus selected from the group comprising: a portable or handheld mobile radio communication equipment, a mobile radio terminal, a mobile telephone, a cellular phone, a pager, a communicator, an electronic organizer, or a smartphone.

31. Mixer equipment for generating music data, comprising:
a mixer device configured to receive at least a first stream of music data from a first music data generator of a first portable communication apparatus external to the mixer equipment and a second stream of music data from a second music data generator of a second portable communication apparatus external to the mixer equipment, mix the first and the second stream of music data to obtain a third stream of music data, and transmit the third stream of music data to at least one of the first and second portable communication apparatuses.

32. The mixer equipment of claim 31, wherein the mixer equipment comprises a music data player operatively connected to the mixer device and the mixer device is configured to feed the third stream of music data to the music data player for playing the third stream of music data.

33. The mixer equipment of claim 31, wherein the mixer device is configured to receive music data in at least one MIDI message that includes instrument data that identifies the type of instrument used to generate the music data.

34. The mixer equipment of claim 31, wherein the mixer device is configured to transmit the third stream of music data in the MIDI file format, and incorporate in the third stream of music data a type of instrument used to generate the third stream of music data having the MIDI file format.

35. The mixer equipment of claim 31, wherein the mixer equipment comprises a radio transceiver operatively connected to the mixer device for receiving the streams of music data.

36. The mixer equipment of claim 31, wherein the mixer equipment comprises a radio transceiver operatively connected to the mixer device for transmitting the third stream of music data.

37. The mixer equipment of claim 31, wherein the mixer equipment is equipment selected from the group comprising: a server, a music application server, or a loudspeaker equipment.

38. A portable communication apparatus for providing music data to a mixer device external to the portable communication apparatus, comprising:
a music data generator configured to detect input data generated in response to a user interacting with the music data generator, and generate a first stream of music data in response to the input data;
a radio transceiver operatively connected to the music data generator configured to transmit the first stream of music data to the mixer device and receive from the mixer device a second stream of music data, the second stream of music data being based on the first stream of music data and one or more other streams of music data generated by an additional music data generator; and
a music data player operatively connected to the radio transceiver, the music data player being configured to receive the second stream of music data for playing the second stream of music data.

39. The portable communication apparatus of claim 38, wherein the music data generator is configured to generate the first stream of data in a MIDI file format, and incorporate in the first stream of music data a type of instrument used to generate the music data having the MIDI file format.

40. The portable communication apparatus of claim 39, wherein the radio transceiver is configured to transmit the first stream of music data in the MIDI file format, and incorporate in the first stream of music data the type of instrument used to generate the first stream of music data having the MIDI file format.

41. The portable communication apparatus of claim 40, wherein the radio transceiver is configured to receive the second stream of music data in at least one MIDI message that includes instrument data that identifies a type of instrument used to generate the second stream of music data.

42. The portable communication apparatus of claim 38, wherein the portable communication apparatus is an apparatus selected from the group comprising: a portable or handheld mobile radio communication equipment, a mobile radio terminal, a mobile telephone, a cellular phone, a pager, a communicator, an electronic organizer, or a smartphone.
